(19) United States
(12) Patent Application Publication
(10) Pub. No.: US 2019/0293444 A1
(43) Pub. Date: Sep. 26, 2019

(54) LANE LEVEL ACCURACY USING VISION OF ROADWAY LIGHTS AND PARTICLE FILTER

(71) Applicant: ARIEL SCIENTIFIC INNOVATIONS LTD., Ariel (IL)

(72) Inventors: Boaz BEN MOSHE, Herzliya (IL); Nir SHVALB, Nesher (IL); Roy YOZEVITCH, Nofim (IL)

(21) Appl. No.: 16/314,428

(22) PCT Filed: Jun. 29, 2017
(86) PCT No.: PCT/IL2017/050725

§ 371 Date: Dec. 30, 2018

Related U.S. Application Data
(60) Provisional application No. 62/356,595, filed on Jun. 30, 2016.

(51) Int. Cl. G01C 21/36; G05D 1/00; G05D 1/02; G05D 1/10; G06T 7/73; G06K 9/00; G08G 1/16

(52) U.S. Cl. CPC G01C 21/3602; G05D 1/0088; G05D 1/0251; G05D 1/101; G06T 7/73; G06K 9/00791; G06T 2207/30252; G05D 2201/0213; G05D 1/0206; G06T 2207/10016; G06T 2207/30244; G06T 2200/24; G08G 1/167

(57) ABSTRACT

There is provided, in accordance with some embodiments, a method comprising using one or more hardware processors for receiving a stream of video frames from a camera mounted on a moving vehicle. Hardware processor(s) are used for computing two or more three-dimensional (3D) orientation vectors of two or more light sources visible in the video frames. Hardware processor(s) are used for computing a 3D location for each of the light sources based on the 3D orientation vectors. Hardware processor(s) are used for computing two or more geographical locations of the camera based on the 3D locations. Hardware processor(s) are used for computing a lane positioning of the vehicle based on the geographical locations. Hardware processor(s) are used for sending the lane positioning and/or the geographical locations to a navigation system.

### BACKGROUND

The invention relates to the field of machine vision.

Vehicle lane detection and lane position tracking may be components in intelligent driver assistance systems. Driving lanes of roads may be defined by solid and/or segmented line markings. Vision-based lane detection systems may track the vehicle's position respective to these markings by following the markings on the road. This concept may be integrated in many commercial lane detection systems and may show good performance in many challenging road and illumination conditions.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with some embodiments, a method comprising using one or more hardware processors for receiving a stream of video frames from a camera mounted on a moving vehicle. Hardware processor(s) are used for computing two or more three-dimensional (3D) orientation vectors of two or more light sources visible in the video frames. Hardware processor(s) are used for computing a 3D location for each of the light sources based on the 3D orientation vectors. Hardware processor(s) are used for computing two or more geographical locations of the camera based on the 3D locations. Hardware processor(s) are used for computing a lane positioning of the vehicle based on the geographical locations. Hardware processor(s) are used for sending the lane positioning and/or the geographical locations to a navigation system.

Optionally, the camera is integrated into a smartphone.

Optionally, the navigation system comprises a user interface for presentation of the lane positioning and/or the geographical locations to an operator of the vehicle.

Optionally, the navigation system sends an alert to a user when the lane positioning and/or the geographical locations of the vehicle is outside of a safe vehicle location boundary.

Optionally, the safe vehicle location boundary is a distance to another vehicle, a position within a driving lane, a position within a roadway, a flying height, and/or a shipping lane.

Optionally, the navigation system is adapted to autonomously control an operation of the vehicle, wherein the operation comprises a location, speed, acceleration, and/or height.

Optionally, the method further comprises querying a database for the geographical locations of some of the 3D locations of the light sources.

Optionally, the method further comprises applying a particle filter to improve the accuracy of the lane positioning.

Optionally, the vehicle is an airborne vehicle and the geographical locations further comprise a vehicle height above the light sources.

There is provided, in accordance with an embodiment, a computer program product for vehicular test generation, the computer program product comprising a non-transitory computer-readable storage medium having program code embodied therewith. The program code executable by hardware processor(s) for receiving a stream of video frames from a camera mounted on a moving vehicle. The program code executable by the hardware processor(s) for computing two or more three-dimensional (3D) orientation vectors of two or more light sources visible in the video frames. The program code executable by the hardware processor(s) for computing a 3D location for each of the light sources based on the 3D orientation vectors. The program code executable by the hardware processor(s) for computing two or more geographical locations of the camera based on the 3D locations. The program code executable by the hardware processor(s) for computing a lane positioning of the vehicle based on the geographical locations. The program code executable by the hardware processor(s) for sending the lane positioning and/or the geographical locations to a navigation system.

There is provided, in accordance with an embodiment, a computerized system comprising a camera, a navigation system, two or more hardware processor, and a non-transitory computer-readable storage medium having program code embodied therewith. The program code executable by the hardware processor(s) for receiving a stream of video frames from a camera mounted on a moving vehicle. The program code executable by the hardware processor(s) for computing two or more three-dimensional (3D) orientation vectors of two or more light sources visible in the video frames. The program code executable by the hardware processor(s) for computing a 3D location for each of the light sources based on the 3D orientation vectors. The program code executable by the hardware processor(s) for computing two or more geographical locations of the camera based on the 3D locations. The program code executable by the hardware processor(s) for computing a lane positioning of the vehicle based on the geographical locations. The program code executable by the hardware processor(s) for sending the lane positioning and/or the geographical locations to a navigation system.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a schematic illustration of a computerized system for determining driving lanes using roadway lights;

FIG. 2 shows a flowchart of a method for determining driving lanes using roadway lights;

FIG. 3 shows a schematic illustration of roadway light orientation vectors from two different lanes;

FIG. 4 shows a schematic illustration of roadway light orientation vectors from three video frames;

FIG. 5 shows a schematic illustration of roadway light positions;

FIG. 6 shows a schematic illustration of roadway curvature estimation from light positions;

FIG. 7 shows pictures of a roadway light video frame; and

FIG. 8 shows pictures of roadway lights in multiple video frames.

### DETAILED DESCRIPTION

Described herein are computer methods, systems, and products for vehicle lane detection and lane position tracking. A video-based approach determines angles to the currently seen light sources located on the sides of and/or above the road may provide an estimated lane position based on a mapping of the light sources and/or a particle filter algorithm. For example, detection of angles to light sources may be an image processing task performed in darkness hours, when roadway lights are turned on. As used herein, the term light sources and/or roadway lights mean light sources visible to the sensor and are used interchangeably. The technique may also be suitable for lane detection inside tunnels. In daylight hours, it may be possible to apply this concept by using feature detection methods to identify the edges of poles of turned off road lights. Optionally, an internet connection allows comparing the visible light sources with a database of light sources from previous detections.

A complementary mechanism for lane detection and lane position tracking may be based on a computer vision solution to detect and identify roadway lights on both sides of a road. The roadway lights may be consistently positioned, such that the distance between consecutive light sources may be substantially constant, and the distance between the road and light sources at one side of the road may also be substantially consistent.

By estimating and tracking the angles to these roadway lights using computer vision the lane may be detected, and the calibration parameters of the camera relative to the vehicle may be constant and known. When the road's geometry and the positioning pattern of roadway lights are also known, the technique may provide highly accurate localization, including lane detection and lane position. When such data may not be available, the system may learn in real time to increase the accuracy of other methods.

The topic of vision-based navigation for vehicles and robots has been widely researched for both indoor and outdoor environments. For indoor environments, light sources may be used as landmarks by a vision-based indoor localization system for mobile robots, in which the ceiling lamps are the landmarks. Vision-based localization may use complex algorithms and hardware resources when related to general environment features. Detecting only the ceiling lamps dramatically reduces the cost and the complexity of the recognition system. An indoor localization system may use detection of light sources. Using a single camera looking upward, a mobile robot may detect positions of spot lightings in the ceiling by simple thresholding of images. The reported positional error in this system may be less than 10 centimeters in a room of 20 by 10 meters, and the update rate may be over 10 hertz (Hz), which may be attributed to the fast identification of light sources. Optionally, aspects of embodiments allow indoor navigation based on visible light sources.

For land vehicles operating outdoors, the motivation to develop full featured vision-based localization systems was not fully apparent until recent years. That may be because Global Navigation Satellite Systems (GNSS), coupled with Map Matching (MM) and Dead Reckoning (DR) techniques, enable fairly accurate localization of vehicles on top of mapped roads. Intelligent driver assistance systems and autonomous vehicles may benefit from a positioning accuracy of tens of centimeters, while positioning methods that are based on GNSS may have an average error of several meters in clear sky conditions, and worse than that in areas such as urban canyons. Optionally, the GNSS sensor is low cost GNSS sensor integrated into a vehicle, a vehicle subsystem, a smartphone, a tablet, and/or the like, and the accuracy of the lane positioning based on the GNSS sensor is improved based on image analysis of roadway illumination structures (such as roadway lighting, building lights, overhead lights, billboard lights, and/or the like) improves the GNSS and lane positioning accuracy. Optionally, the positioning based on visible light sources is used instead of a GNSS or where a GNSS does not operate, such as indoors, in warehouses, in tunnels, in underground parking garages, and/or the like.

Finding white markings on a dark road may be difficult to determine, such as lane markings on various types of road, due to shadows, occlusion by other vehicles, changes in the road surfaces itself, wear of the markings, and/or differing types of lane markings. The road markings may vary greatly over nearby stretches of the same road. Existing vision-based systems may detect solid and segmented line markings on top of the road. In various situations, however, such as bad lighting conditions and/or crowded roads, following the lines on the road may be difficult.

A situation in which vision-based detection of lane markings may perform poorly may be in cluttered roads with unclear markings or no markings at all. In such cases, the system would typically fallback to using other sensors. A system for autonomous vehicle guidance may fuse vision-based detection of lane boundaries with Differential Global Positioning System (DGPS) and Inertial Navigation System (INS). DGPS may have limitations arising from slow updates, signal interference, and limited accuracy. Systems may estimate the position of vehicles by integrating DGPS with INS or imaging sensors.

Lane detection and lane positioning may include two distinct phases. A first phase may be a mapping of roadway lights. This may be performed automatically and independently using various approaches. A second phase may be real time lane detection and lane positioning. Landmarks may be accurately mapped, so the locations of roadway lights may be considered as known. An autonomous variation may not rely on prior mapping, such as access to a database of roadway and light locations. Optionally, the first phase is used to map the light sources independently of the lane positioning, such as for maintenance, city mapping, relative positioning of vehicles, calibration of GPS signals, and/or the like.

Following are computer vision techniques for the detecting, filtering, and tracking of roadway lights. The problem of light source detection may be considerably less complex and resource consuming compared to general feature detection in video frames.

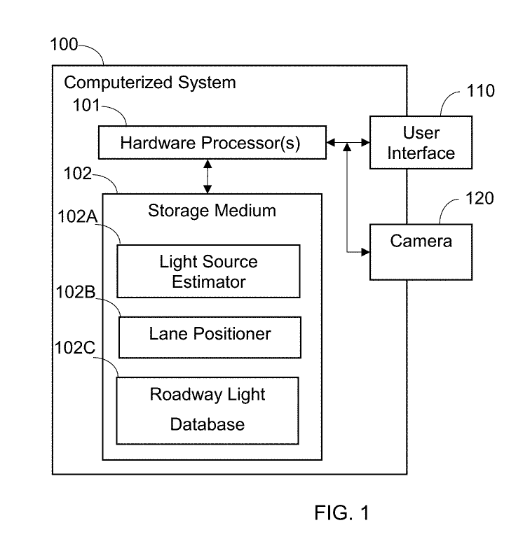

Reference is now made to FIG. 1, which is a schematic illustration of a computerized system 100 for determining driving lanes using roadway lights. Hardware processor(s) 101 retrieve program code stored on a storage medium 102, optionally program code may be arranged in modules. For example, a light source estimator 102A module may contain processor instructions that when executed on hardware processor(s) 101 adapt processor(s) 101 to retrieve video frames from a camera 120, analyze frames to determine light sources, compute orientation vectors to light sources, and compute light source locations. A lane positioner 102B module may adapt processor(s) 101 to compute a lane position from the orientation vectors and/or light source locations, optionally by retrieving a map of roadway lights from a roadway light database 102C, and locating the light source locations on the map. Lane position may be then sent to a user interface 110, optionally overlaid on the map.

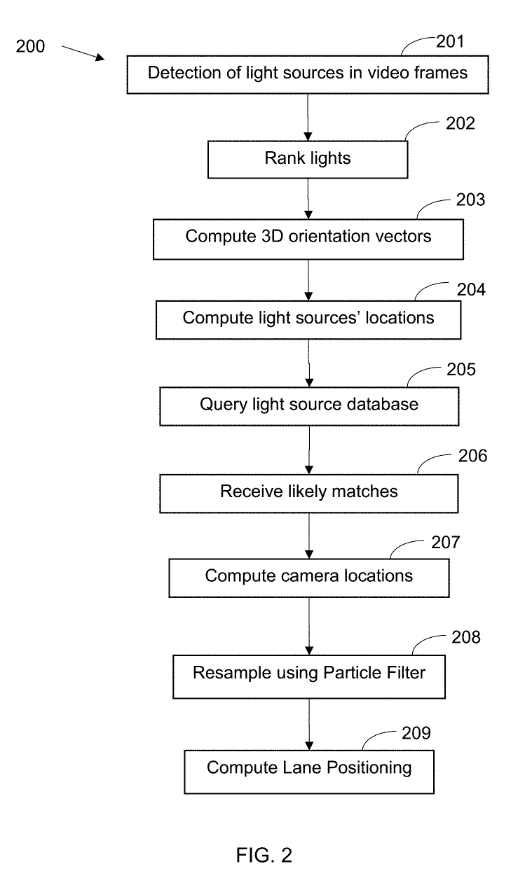

Reference is now made to FIG. 2, which is a flowchart of a method 200 for determining driving lanes using roadway lights. Optionally, the method may be performed in real time and/or automatically. Roadway lights are detected 201 in the frames of video collected on camera 120. A small number of video frames (e.g., 5 frames) are used to rank 202 the light sources in the input video by rating a change of pixel position and rating of change of light source sizes. A number of the brightest light sources may be ranked simultaneously. Orientation vectors (3D) for each light source are computed 203 from the camera data. Light source 3D locations are computed 204 by a law of sines to find the Latitude/Longitude positions and heights above the ground of the detected light sources.

A database of mapped roadway lights may be queried 205 to retrieve a group of most likely matches on a geographical map. Each such match may be comprised of: (a) a mapped light source corresponding to the Most Significant Light in the frame; (b) a Matching Score that may be based on the aggregate Euclidean distance between the set of lights identified in the video and their best matches in the database. Given a digital map of the road network, this step may include additional filtering and optimization based on Map Matching and Dead Reckoning. Each matched location received 206 from the database corresponds to a suspected matched camera location computed 207 using the law of sines. The mapped light sources may be accurately mapped (such as using Latitude, Longitude, and height) and the Orientation Vectors may also be known.

A particle filter may be used for re-sampling 208 of possible camera locations: re-sampling uniformly distributed new particles, as well as deleting unlikely particles are both based on spatial proximity to suspected locations computed in the previous step and their corresponding Matching Score retrieved from the database. In each generation of the particle filter, the particle with the highest weight represents the currently estimated camera locations. Location retrieved from the database may be good approximations of the true camera location. The particles, however, are continuously re-sampled in a random manner, so the highest weight particle may not be identical to any of the suspected solutions. Convergence to the true camera location occurs when the particle with the highest weight may be spatially very close to a recent suspected camera location. Compute 209 lane position information based on camera locations and roadway digital maps received from database 102C.

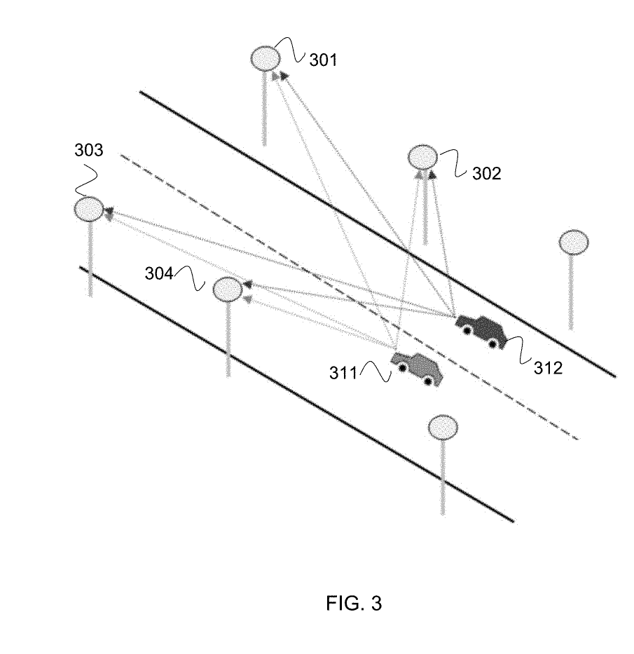

Reference is now made to FIG. 3, which is a schematic illustration of roadway light orientation vectors from two different lanes. Lane location 311 and 312 may be detected from angles to roadway lights 301, 302, 303, and 304. The 3D orientation vectors to light sources may differ between the car in the right lane (312) and the car in the left lane (311). When the locations of roadway lights are accurately mapped and 3D orientation vectors to viewed light sources are computed, then the lane locations of the vehicles may also be computable by trigonometric formulas.

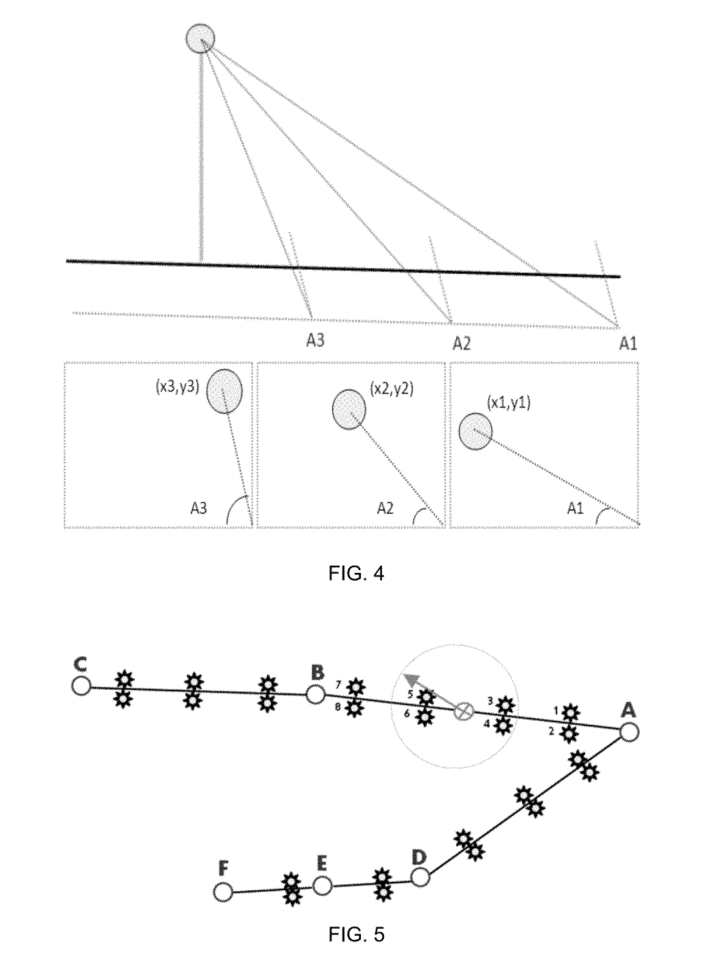

Reference is now made to FIG. 4, which is a schematic illustration of roadway light orientation vectors from three video frames. The rate-of-change of the angle to a light source in consecutive video frames may be computed. The angles A1-A3 may be computed using simple two-dimensional (2D) trigonometry based on the (x, y) pixel position of the light source. Given the vehicle's velocity, the algorithm may compute the angle's rate of change in degrees per meter.

A data model for lane detection may support the following operations. Real-time database queries that match light source locations captured by the camera with candidate roadway lights that are accurately mapped in the database. Association of mapped roadway lights to mapped road segments. A computer vision-based embodiment may apply the fields of three-dimensional (3D) vision and epipolar geometry, but full 3D support may not be required. For example, turned on roadway lamps may have relatively simple features, and may be further simplified to the lamps' height above the ground. This may be in comparison to other vision systems, which may attempt to map and then match complex varying features that may be described in a 3D coordinate system.

The data model for storing mapped roadway lights may be based on standard spatial geographic databases. For example, existing spatial databases may not be fully supportive of 3D operations such as distance in a 3D space. Each mapped roadway light in the database may be represented by its World Geodetic System (WGS) coordinates, as well as height above the ground, size and shape parameters. The distance queries against the database are therefore in two-dimensional (2D) space. Therefore, estimated 3D orientation vectors to light sources that the camera captures may be flattened to azimuth before a query takes place.

Transformation of the location to a 3D location occurs when the algorithm determines that a specific mapped light source in the database may be corresponding to a light source that was captured by the camera. The algorithm then transforms the result to 3D using: (i) the 3D Orientation Vector to the light source extracted from the video, and (ii) the Latitude position, Longitude position, and height of the mapped light source.

A database may be compliant with Open Geospatial Consortium (OGC) specifications, in which locations may be defined in World Geodetic System (WGS) coordinates. A light source may be stored in the database with Latitude and Longitude locations, and additional parameters such as height, size, and shape of lamps.

Using estimated GNSS position: Recall that the need for proprietary algorithms for lane detection stems from the insufficient accuracy of GNSS modules. Nevertheless, in most cases, the GNSS module provides a fairly accurate position estimation that simplifies the design of the model: Given an estimated Latitude position and Longitude position in the World Geodetic System (WGS), there may be only a small number of mapped roadway lights in the model that are near this location. Because the smartphone' s camera orientation may also be known during the real-time phase, the model may store each mapped roadway light as a simple record that only contains: (a) location of the roadway light and (b) reference to the road section on which this roadway light resides.

Map Matching may comprise a reference of a mapped roadway light to the appropriate road section (e.g., as a foreign key in the database) which may enable the inclusion of map matching algorithms. The roadway lights in the model may therefore be thought of as a layer that may be stored in a separate shapefile, or in a separate table within a geospatial database such as PostGIS. The road sections may also be stored as a separate layer, where each section's geometry may be represented as line segments that comprise a sequence of WGS points. A map matching algorithm may either keep track of the current road section, or perform an independent search for each estimated GNSS position. The process of placing a vehicle having an estimated location on top of a known road may be documented and works in most cases. The output of this process may be a refined estimated position that coincides with the road network.

Reference is now made to FIG. 5, which is a schematic illustration of roadway light positions. The estimated GNSS position (cross) assists to locate the camera on the correct road segment using map matching, and the known orientation to a detected light source (arrow) assists to find the most likely corresponding roadway lights in the model.

This example illustrates a simplified scenario of a real-time query against a data model. The device's estimated GNSS position and Map Matching may be used to locate the device on the road segment A-C (such as at the cross). A small set of nearby mapped roadway lights on the A-C road section may be extracted (as in dotted circle). The driving direction may be used to further reduce the set of candidate solutions, such that points 3 and 4 may be eliminated from consideration. The known Orientation Vector from the camera to the Most Significant Light (see arrow) may be provided in a query of the following forms: (a) the estimated position of the Most Significant Light may be explicitly specified in the query; (b) the Orientation Vector may be transformed into a couple of points with WGS coordinates. The first option may be adequate when a quick image processing stage succeeds to extract good depth estimations of the light sources, while the second option may be used when a depth estimation is time consuming and slows the process. From the remaining candidate locations, the locations having the smallest distance to the vector are returned as candidate solutions.

Note that most geospatial databases (e.g., PostGIS) may have built-in functions supporting distance computations. In this simplified example, there may be just one light source in the database (point 5) that fits the parameters of the query. This may often be the case in open road scenarios where the estimated GNSS position may be fairly accurate. However, in other cases there may be multiple candidate solutions that may be considered.

Optionally, inside a tunnel the lights may often be very close to one another, and the GNSS position estimate may be inaccurate.

Positioning a camera on the lane may be performed at the corrected location of the vehicle on top of a lane. Two approaches for achieving this may be used. In the first visually-based approach, the road map in the geographical information systems (GIS) may be accurate in terms of overall road width and lane allocation. Thus, in a zoomed-in view of the road, a location may be drawn on the correct lane using its global (Latitude and Longitude) coordinates.

Most GISs may represent roads with polylines, a representation that simplifies roads to their center lines. Such representation of roads may be insufficient for lane positioning, and a correction may be to associate to each road segment meta data parameters that store its number of lanes and overall width. Geospatial databases such as PostGIS may have built-in functions for computing the perpendicular distance between a Point and a Polyline. Using this distance, the location and the segment's width and number of lanes may be computed to estimate the current driving lane.

In vision-based or vision-assisted localization systems, landmarks along most trajectories may have already been mapped. This reduces the problem of localization to online phase matching against a database. Because this database may be created and optimized in the context of an offline process using calibrated tools, the potential accuracy may be significantly better in comparison to self-localization in unfamiliar trajectories.

In some systems, landmarks may not have been mapped along all trajectories. A new system may, therefore, include SLAM capabilities, in order to support self-localization along trajectories which haven't been mapped yet. This type of vision assisted self-localization may constitute the basis for mapping roadway lights using thin agents (e.g., smartphone devices), rather than designated high profile vehicles (e.g., Google Street View cars).

Many commercial lane detection systems do not provide lane curvature information, but just lane positions. Lane marking detection algorithms may deal with curvatures and challenging situations. The lane curvature may be estimated based on line markings on the road. The disadvantage of this technique may be that in many situations the vehicle's cameras may only capture line markings that are a few meters ahead. Thus, lane curvature may be estimated in real-time, but may not be anticipated in advance. In contrast, roadway lights, due to their height, may be detected from farther away, in various lighting and weather conditions. Because the imaginary curved line connecting the roadway lights at one side of the road may be roughly parallel to the lanes' curvature, it may be possible to estimate the curvature in advance using the methods suggested above, with the advantage of early curvature anticipation. Optionally, lights from both sides of the road may be used to detect lane curvature and/or location.

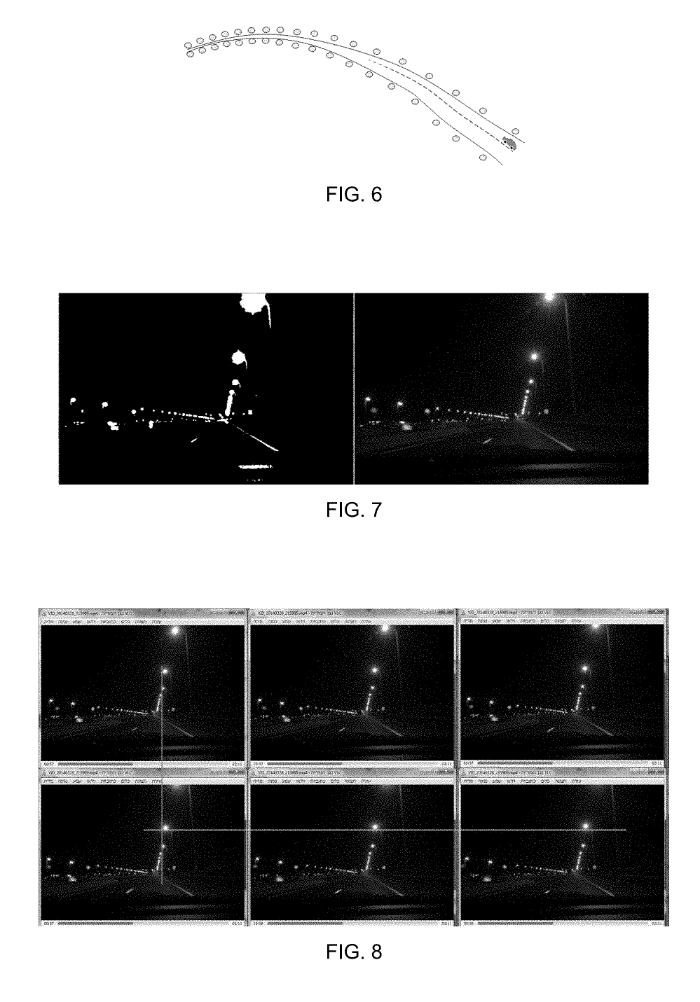

Reference is now made to FIG. 6, which is a schematic illustration of roadway curvature estimation from light positions. In many cases, the vehicle's vision-based system may use roadway lights to detect in distant curvatures of the lane and/or road. In comparison, curvature detection based on line markings has a limited range.

Reference is now made to FIG. 7, which are pictures of a roadway light video frame. The maximum pixel offsets between frames of a tracked light feature are small, and binarization may be applied to partial blocks of the frame to improve the computational performance.

Reference is now made to FIG. 8, which are pictures of roadway lights in multiple video frames. The consecutive video frames in the figure may be captured by a smartphone's front and/or rear camera, a vehicle's permanent camera, a vehicle subsystem camera (such as the camera of a Mobileye® system) and/or the like, at a rate of approximately 25-30 frames per second (FPS). With a driving speed of 100 kilometers per hour, this translates to approximately one-meter vehicle traveling distance between consecutive frames. The vertical line shows the X-axis pixel-wise offset of a light source in 4th frame relative to the 1st frame, while the horizontal line shows the Y-axis pixel-wise offset of this light source between the 4th and 6th frames.

It may be seen in the figure that the horizontal and vertical pixel offsets of a nearby light source between close frames are only few pixels. Distant light sources may therefore be filtered out either on the basis of unchanged pixel position over the course of several frames, or on the basis of unchanged pixel size of the light source feature.

The initial detection in a video frame of suspected light source features may be straightforward. During night conditions, it may be performed using a simple and quick threshold that transforms a colored RGB image frame into binary black and white.

Optionally, an aircraft uses detection of roadway lights and/or light sources to navigate. Optionally, an unmanned aircraft uses detection of roadway lights to navigate. An aircraft may track the lights along a roadway, and compute orientation vectors to each light as it is moving. This may allow the aircraft to compute a 3D location, such as latitude, longitude, and height. Optionally, the height is relative to the ground. Optionally, the orientations of the roadway lights are used to determine a minimum flying height to avoid collision, such as a collision with a tree, a power line, a building, and the like. Optionally, the roadway lights are compared to a database of geographical locations, and an aircraft location is determined from the comparison.

Optionally, the 3D location of the vehicle is used to autonomously control the operation of the vehicle, such as the flying of an airplane sing an auto-pilot, driving or a car, driving or a train, driving of a truck, sailing of a boat, and the like.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as

Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of modified purpose computer, special purpose computer, a general computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising using at least one hardware processor for:
receiving a stream of video frames from a camera mounted on a moving vehicle;
computing a plurality of three-dimensional (3D) orientation vectors of a plurality of light sources visible in said video frames;
computing a 3D location for each of said plurality of light sources based on said plurality of 3D orientation vectors;
computing a plurality of geographical locations of said camera based on said 3D locations;
computing a lane positioning of said vehicle based on said plurality of geographical locations;
sending at least one of said lane positioning and said plurality of geographical locations to a navigation system.

2. The method according to claim 1, wherein the navigation system comprises a user interface for presentation of the at least one of said lane positioning and said plurality of geographical locations to an operator of said vehicle.

3. The method according to claim 1, wherein the navigation system sends an alert to a user when at least one of said lane positioning and said plurality of geographical locations of said vehicle is outside of a safe vehicle location boundary.

4. The method according to claim 3, wherein the safe vehicle location boundary is at least one of a distance to another vehicle, a position within a driving lane, a position within a roadway, a flying height, and a shipping lane.

5. The method according to claim 1, wherein the navigation system is configured to autonomously control an operation of said vehicle, wherein the operation comprises at least one of a location, speed, acceleration, and height.

6. The method according to claim 1, further comprising querying a database for the geographical locations of some of said 3D locations of said plurality of light sources.

7. The method according to claim 1, further comprising applying a particle filter to improve the accuracy of said lane positioning.

8. The method according to claim 1, wherein the vehicle is an airborne vehicle and the plurality of geographical locations further comprise a vehicle height above the plurality of light sources.

9. The method according to claim 1, wherein the camera is integrated into at least one of a smartphone, a vehicle, and a vehicle subsystem.

10. The method according to claim 1, wherein the actions of the method are performed automatically.

11-20. (canceled)

21. A computerized system comprising:
a camera;
a navigation system;
at least one hardware processor; and
a non-transitory computer-readable storage medium having program code embodied therewith, the program code executable by the at least one hardware processor for:
receiving a stream of video frames from a camera mounted on a moving vehicle;
computing a plurality of three-dimensional (3D) orientation vectors of a plurality of light sources visible in said video frames;
computing a 3D location for each of said plurality of light sources based on said plurality of 3D orientation vectors;
computing a plurality of geographical locations of said camera based on said 3D locations;
computing a lane positioning of said vehicle based on said plurality of geographical locations;
sending at least one of said lane positioning and said plurality of geographical locations to the navigation system.

22. The computerized system according to claim 21, wherein the navigation system comprises a user interface for presentation of the at least one of said lane positioning and said plurality of geographical locations to an operator of said vehicle.

23. The computerized system according to claim 21, wherein the navigation system sends an alert to a user when at least one of said lane positioning and said plurality of geographical locations of said vehicle is outside of a safe vehicle location boundary.

24. The computerized system according to claim 21, wherein the safe vehicle location boundary is at least one of a distance to another vehicle, a position within a driving lane, a position within a roadway, a flying height, and a shipping lane.

25. The computerized system according to claim 21, wherein the navigation system is configured to autonomously control an operation of said vehicle, wherein the operation comprises at least one of a location, speed, acceleration, and height.

26. The computerized system according to claim 21, further comprising program code configured to query a database for the geographical locations of some of said 3D locations of said plurality of light sources.

27. The computerized system according to claim 21, further comprising program code configured to apply a particle filter to improve the accuracy of said lane positioning.

28. The computerized system according to claim 21, wherein the vehicle is an airborne vehicle and the plurality of geographical locations further comprise a vehicle height above the plurality of light sources.

29. The computerized system according to claim 21, wherein the camera is integrated into at least one of a smartphone, a vehicle, and a vehicle subsystem.

30. The computerized system according to claim 21, wherein the actions of the method are performed automatically.
